(19) United States
(12) Patent Application Publication
(10) Pub. No.: US 2007/0133469 A1
(43) Pub. Date: Jun. 14, 2007

(54) Sensor node device and method for supporting mobility of mobile node in sensor network

(75) Inventors: Chang Min Shin, Daejeon (KR); Seung Min Park, Daejeon (KR); Dong Shin Kim, Seoul (KR); Joong Heon Kim, Seoul (KR); Won Jun Lee, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Rsearch Institute

(21) Appl. No.: 11/604,002

(22) Filed: Nov. 21, 2006

(30) Foreign Application Priority Data
Dec. 8, 2005 (KR) 2005-119488
Jun. 15, 2006 (KR) 2006-53774

(51) Int. Cl. H04Q 7/00

(52) U.S. Cl. 370/331

(57) ABSTRACT

Provided are a sensor node device and method for supporting mobility of a mobile node in a sensor network. The sensor node device includes: a network interface for communicating with a sink node, at least one neighboring sensor node, and the mobile node; a mobility supervisor for detecting a location of the mobile node, and deciding a sensor node for a service of a data packet received through the network interface on the basis of the detected location; a transmission decision maker for deciding a transmission mode for the data packet received through the network interface according to the location of the mobile node; and a state reporter for reporting a transmission state of the data packet through the sensor node device. When the mobile node moves to a place where radio wave propagation areas of sensor nodes overlap each other, the radio wave intensity of each sensor node is detected to perform a handoff to the sensor node of the area having the strongest radio wave intensity. Thus, a ping-pong problem caused by unnecessary repeated handoff, and a delay problem caused by too slow handoff, can be prevented.

### CROSS-REFERENCE TO RELATED APPLICATION

This application claims priority to and the benefit of Korean Patent Application Nos. 2005-119488, filed Dec. 8, 2005, and 2006-53774, filed Jun. 15, 2006, the disclosures of which are incorporated herein by reference in their entirety.

### BACKGROUND

1. Field of the Invention

The present invention relates to a sensor node device and method for supporting mobility of a mobile node in a sensor network, capable of seamlessly transmitting packets regardless of whether or not a node moves in a sensor network environment.

2. Discussion of Related Art

Internet Engineering Task Force (IETF) has proposed Mobile Internet Protocol (IP) as a method for supporting mobility of a mobile node in an Internet environment. Mobile IP uses a technique of registering information on a location through a temporary IP address, a care-of address, whenever the node changes an access point.

A Mobile IP handoff results from a link-layer handoff between different IP networks. Due to independence between layers, it is impossible to notify the network layer Mobile IP that the link-layer handoff takes place. Hence, Mobile IP requires another method for determining a handoff point of time. To this end, all mobility agents using Mobile IP periodically broadcast an Advertisement message.

The mobile node receives the broadcast Advertisement message, thereby discovering its own mobility agent. Further, the mobile node can detect its relative location using the Advertisement message. For example, when failing to receive the third consecutive Advertisement message from the mobility agent, the mobile node recognizes that it is outside of an existing network to which it belongs.

In Mobile IP version 6 (MIPv6), an Eager Cell Switching (ECS) algorithm and a Lazy Cell Switching (LCS) algorithm are proposed as move detection algorithms for determining through the Advertisement message when to perform a handoff of the mobile node.

The ECS algorithm is aimed at performing a Mobile IP handoff to a new network as fast as possible. In other words, as soon as the mobile node discovers a new mobility agent that it can communicate with, i.e., as soon as the mobile node receives the Advertisement message of a new mobility agent, a handoff is performed.

The ECS algorithm detects movement of the mobile node using an agent address included in the Advertisement message. When communication between the mobile node and the mobility agent is temporarily interrupted due to failure in data transmission on a radio frequency channel, the communication is resumed when the mobile node receives the Advertisement message from the mobility agent again.

Because Mobile IP has no way of knowing about the communication interruption with the existing mobility agent, which is caused by the link-layer handoff due to independence of layers, the mobile node in the ECS algorithm recognizes movement to another network through the Advertisement message from the new mobility agent. Whenever the mobile node receives the Advertisement message from any mobility agent other than the currently connected mobility agent, a handoff is performed to the new mobility agent.

The LCS algorithm aims at avoiding a Mobile IP handoff until absolutely necessary. To be specific, only when communication with the currently connected mobility agent is completely cut off does the mobile node perform a handoff to a new mobility agent.

In the LCS algorithm, the mobile node recognizes movement to another network through a lifetime of the Advertisement message of the mobility agent. Whenever the mobile node receives the Advertisement message from the mobility agent, countdown of the lifetime begins. When the lifetime expires, the mobile node moves to another network, determines that it is impossible to communicate with the currently connected mobility agent, and thus a handoff is performed.

The mobile node maintains lifetimes of all mobility agents that are successful in transmitting the Advertisement message. When it is impossible to communicate with the currently connected mobility agent, the mobile node registers itself with another mobility agent whose lifetime has not expired. If there is no mobility agent whose lifetime has not expired, the mobile node searches for a new mobility agent with which it can communicate through agent solicitation.

However, the ECS algorithm rapidly responds to movement of the mobile node, but requires the following assumption with respect to a type of movement of the mobile node in order to perform efficient switching. The mobile node must move in a single direction and not return to a previous mobility agent immediately after the switching is performed. If the movement of the mobile node does not match this assumption, handoffs are repeatedly performed unnecessarily, a result known as a “ping-pong” effect. Thus, the ECS algorithm can perform rapid handoff, but leads to the “ping-pong” effect when the mobile node is situated on the boundary between two cells.

The LCS algorithm requires no assumption regarding the type of movement of the mobile node in order to guarantee switching efficiency, and can prevent frequent handoff. However, because it is not until the mobile node is disconnected with the current mobility agent that a handoff to another mobility agent is attempted, there is a problem in that the LCS algorithm always responds slowly to the movement of the mobile node. In other words, handoff is delayed.

Further, Mobile IP supporting node mobility has the advantage of being suitable for a wireless network based on IP, but the disadvantage of being unsuitable for a sensor network that does not use IP.

A mechanism for transmitting data in a conventional sensor network involves setting a transmission route and transmitting data along the route. When the route is changed due to change in location of a node, data transmission is delayed until the transmission route is updated and packets are lost.

In addition, it is impossible to transmit data during a delay caused by updating the transmission route, which is a serious factor lowering user satisfaction.

### SUMMARY OF THE INVENTION

The present invention is directed to a sensor node device and method for supporting mobility of a mobile node in a sensor network, capable of supporting continuous mobility which is suitable for the wireless sensor network environment and minimizes packet loss.

The present invention is also directed to a sensor node device and method for supporting mobility of a mobile node in a sensor network, capable of seamlessly transmitting packets to a node that moves in the sensor network.

The present invention is also directed to a sensor node device and method for supporting mobility of a mobile node in a sensor network, capable of supporting a seamless communication environment regardless of whether or not a node moves in order to accurately transmit a packet in a sensor network environment.

One aspect of the present invention provides a sensor node device for supporting mobility of a mobile node in a sensor network. The sensor node device comprises: a network interface for communicating with a sink node, at least one neighboring sensor node, and the mobile node; a mobility supervisor for detecting a location of the mobile node, and deciding a sensor node for a service of a data packet received through the network interface on the basis of the detected location; a transmission decision maker for deciding a transmission mode for the data packet received through the network interface according to the location of the mobile node; and a state reporter for reporting a transmission state of the data packet through the sensor node device.

Another aspect of the present invention provides a method for supporting mobility of a mobile node in a sensor network. The method comprises the steps of: determining, by the mobile node, whether or not sensor switching is required using a Received Signal Strength Indication (RSSI) of each sensor node and a threshold value; when it is determined that sensor switching is required, deciding a target sensor node using the RSSI of each sensor node and the threshold value; performing a handoff to the decided target sensor node; setting an optimal route through the decided target sensor node; and transmitting/receiving a data packet using the set optimal route.

Yet another aspect of the present invention provides a method for processing handoff of a mobile node in a sensor network. The method comprises the steps of: measuring a Received Signal Strength Indication (RSSI) of each neighboring sensor node using an Advertisement message periodically transmitted from each neighboring sensor node; determining whether or not there is a neighboring sensor node whose measured RSSI exceeds a preset threshold value; when it is determined that there is a neighboring sensor node whose measured RSSI exceeds the preset threshold value, measuring the RSSI of a source sensor node performing a current data packet service; when the measured RSSI of the source sensor node does not exceed the threshold value, transmitting a Pre-forwarding message to the source sensor node and deciding as a target sensor node the sensor node having the strongest RSSI among the neighboring sensor nodes; transmitting a Rerouting Request message to the target sensor node; when the. Rerouting Request message is received from the target sensor node, transmitting/receiving a data packet through the target sensor node.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 schematically illustrates the configuration of a sensor network according to the present invention;

FIG. 2 is a schematic block diagram illustrating the configuration of a sensor node device for supporting seamless mobility of a mobile node in a sensor network according to the present invention;

FIG. 3 illustrates the configuration of a routing table according to the present invention;

FIG. 4 illustrates a format of a data packet according to the present invention;

FIGS. 5A and 5B are flowcharts illustrating a method of processing handoff of a mobile node when a sensor node is mobile according to an exemplary embodiment of the present invention;

FIGS. 6A and 6B are flowcharts illustrating a method of processing handoff of a mobile node when a sensor node is stationary according to another exemplary embodiment of the present invention; and

FIG. 7 is a flowchart illustrating a method of transmitting a data packet when a mobile node is handed off according to the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are provided for complete disclosure of the present invention and to fully inform the scope of the present invention to those of ordinary skill in the art.

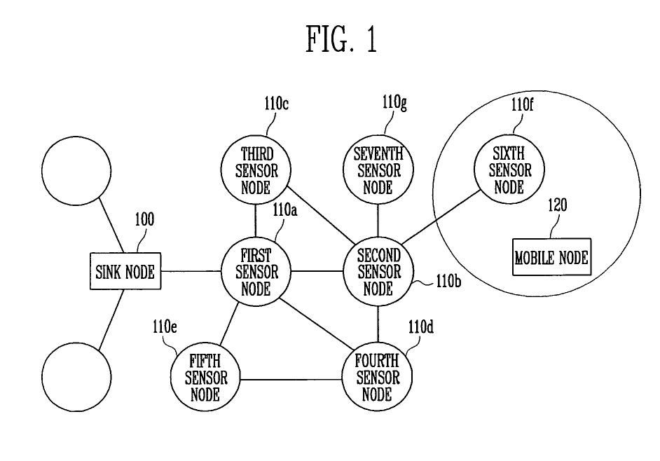

FIG. 1 schematically illustrates the configuration of a sensor network according to the present invention.

Referring to FIG. 1, the sensor network includes a sink node 100, at least one sensor node 110, and a mobile node 120.

The sink node 100 receives data transmitted by the sensor nodes 110 constituting the sensor network, or transmits data to the sensor nodes 110.

Further, when a Routing Request (RREQ) message for the mobile node 120 is received from any one of the sensor nodes 110, the sink node 100 uses the route along which the RREQ message is transmitted to set a route for routing, and transmits a Routing Reply (RREP) message to the sensor node 110.

Further, when sensor switching takes place due to handoff of the mobile node 120, the sink node 100 sets an optimal route for communicating with the mobile node 120, and transmits/receives data packets through the set optimal route.

The sensor nodes 110 collect information of the mobile node 120 and transmit it to the sink node 100. The sink node 100 may be mobile to some extent, rather than stationary.

The sensor nodes 110 situated within a predetermined distance from the sink node 100 directly transmit data to the sink node 100, while the other sensor nodes 100b, 110d, 110f, and 110d situated beyond the predetermined distance from the sink node 100, instead of directly transmitting data to the sink node 100, transmit data to the sensor nodes 110a, 110c, and 110e neighboring the sink node 100 which then transmit the data to the sink node 100.

As described above, the reason the sensor nodes 110 situated beyond the predetermined distance from the sink node.100 transmit data using the neighboring sensor nodes is for minimizing power consumed in data transmission. This is based on the fact that power consumed to transmit data from a sensor node 110 to the sink node 100 is roughly proportional to the distance between the sensor node 110 and the sink node 100.

Hence, the sensor nodes 100b, 110d, 110f, and 110d situated beyond the predetermined distance from the sink node 100 transmit data using the plurality of sensor nodes 110a, 110c, and 110e, so that it is possible to minimize power consumed in data transmission.

Further, the sensor nodes 110 periodically transmit an Advertisement message to the mobile node 120, thereby allowing the mobile node 120 to detect the neighboring nodes.

When a Rerouting message is received from the mobile node 120, the sensor node 110 creates and broadcasts an RREQ message so that the RREQ message can be transmitted to the sink node 100. Then, when an RREP message is received from the sink node 100, the sensor node 110 transmits a Rerouting Reply message to the mobile node 120.

Further, the sensor node 110 sets a distance less than its transmission radius as a threshold value. When the mobile node 120 is more distant than the threshold value, the sensor node 110 transmits a packet to be transmitted to the mobile node 120 to the mobile node 120 as well as to the neighboring sensor nodes.

To be specific, when the mobile node 120 is more distant than the threshold value, the sensor node 110 determines that the mobile node 120 will soon enter the transmission radius of another sensor node to prompt sensor switching, and thus transmits the packet to the mobile node 120 as well as the neighboring sensor nodes. A method of setting the threshold value for the distance between the mobile node 120 and the sensor node 110 makes use of Received Signal Strength Indication (RSSI).

When a Pre-forwarding message is received from the mobile node 120, the sensor node 110 transmits a packet to be transmitted to the mobile node 120 to the mobile node 120 and neighboring sensor nodes.

Specifically, the sensor node 110 receiving the Pre-forwarding message transmits data to be transmitted to the mobile node 120 to the mobile node 120 and simultaneously to the neighboring sensor nodes, thereby allowing the mobile node 120 to seamlessly receive the data even when outside of the transmission radius of the sensor node. Because the sensor node 110 does not know to which sensor node the mobile node 120 will be sensor-switched, the sensor node 110 unconditionally transmits the packet to all neighboring sensor nodes managing areas adjacent to its transmission area.

In this manner, any neighboring sensor node receiving the packet from the sensor node 110 broadcasts the received packet within its transmission radius. In other words, because no neighboring sensor node knows when the mobile node 120 enters its transmission radius to prompt sensor switching, the neighboring sensor node unconditionally broadcasts the received packet within its transmission radius, thereby minimizing delay and packet loss when sensor switching is performed.

Further, when the packet is received from the sink node 100 or any neighboring sensor node, the sensor node 110 checks information of the mobile node from a routing table using an identification (ID) of the mobile node included in the received packet. If the mobile node ID does not exist in the routing table (i.e., when the mobile node first enters the transmission radius of the sensor node), the sensor node 110 registers the information of the mobile node in the routing table.

If the mobile node ID is listed in the routing table, the sensor node 110 determines whether or not the mobile node is within its transmission radius. If it is determined that the mobile node is not within its transmission radius, the sensor node 110 transmits a packet to the next sensor node on the data transmission route.

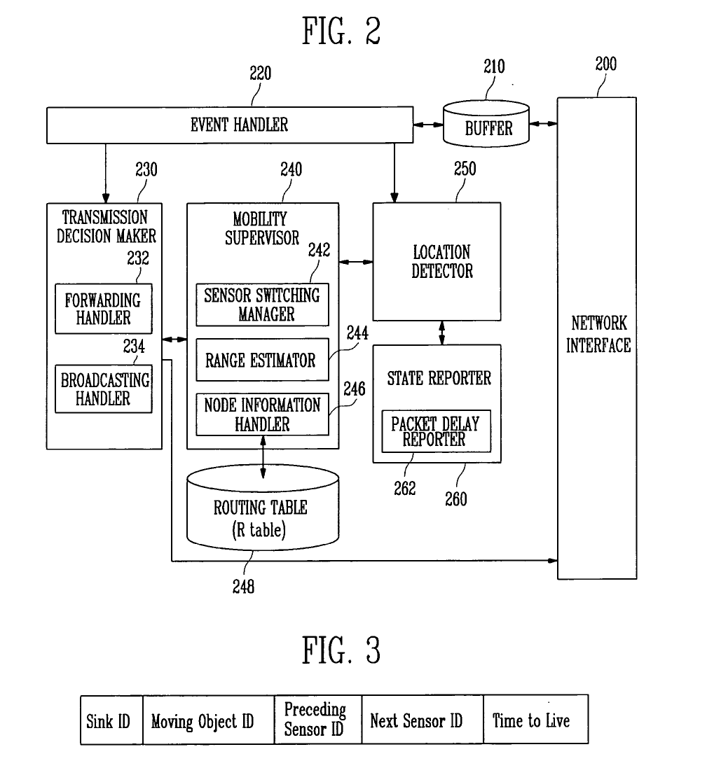

The sensor node 110 performing the above-described functions will be described with reference to FIG. 2.

The mobile node 120 continuously receives Advertisement messages from neighboring sensor nodes, and measures the RSSI of the neighboring sensor nodes using the received Advertisement messages. Then, the mobile node 120 decides a target sensor node and a point of time to perform sensor switching using the measured RSSIs.

In order to reduce delay and packet loss when sensor switching is performed, the sensor network configured as described above must be capable of continually observing movement of the mobile node 120 and recognizing in real time when the mobile node 120 deviates from the transmission radius of a current sensor node into the transmission radius of another sensor node.

For this reason, each sensor node 110 periodically broadcasts the Advertisement message. Then, the mobile node 120 measures the RSSI of neighboring sensor nodes using the Advertisement message, and decides a target sensor node and a proper point of time to perform sensor switching using the measured values. In other words, the mobile node 120 becomes more and more distant from a source sensor node currently providing a service, and sensor switching is performed when the RSSI of a neighboring sensor node exceeds the threshold value.

When the RSSI of a neighboring sensor node does not exceed the threshold value, the mobile node 120 transmits a Pre-forwarding message to the source sensor node. Then, the source sensor node predicts sensor switching of the mobile node 120, determines that sensor switching will soon be performed, and transmits the packet to the neighboring sensor nodes.

With the method of deciding a target sensor node and a point of time to perform sensor switching using the Advertisement message, and the method of pre-forwarding the packet using the threshold value, it is possible to reduce delay and packet loss when sensor switching is performed. However, the route for transmitting the packet to the mobile node 120 may cause problems after sensor switching, because a new sensor node 110 is simply added on an existing packet transmission route.

Further, as the number of times sensor switching is performed for the mobile node 120 increases, delay increases until the mobile node 120 receives the packet from the sink node 100, and energy consumption increases in the entire sensor network in order to transmit one packet to the mobile node 120. Hence, the sink node 100 must enhance efficiency of packet transmission by selecting an optimized packet transmission route.

However, if the packet transmission route is optimized whenever the mobile node 120 performs sensor switching, the number of control packets transmitted from the sensor node 110 to the sink node 100 increases thus generating high overhead.

As such, the sink node 100 must optimize the route only when it is determined that the mobile node 120 will not undergo sensor switching for a predetermined time. For example, if the mobile node 120 is adjacent to the current sensor node, it can be predicted that the mobile node 120 will not undergo sensor switching for a predetermined time. Thus, when the distance between the mobile node 120 and the current sensor node is less than the threshold value used in the packet pre-forwarding method, the route is optimized.

In this manner, when the optimal route for communicating with the mobile node 120 is set, the sink node 100 communicates with the mobile node 120 using the set optimal route.

However, when packets are transmitted to the mobile node 120 through the optimized route, they may be transmitted out of sequence.

Hence, in order to maintain the sequence of the transmitted packets, prior to switching an existing route to an optimal route, the sink node 100 waits for the difference between transmission delays on the two routes, and transmits the packet using the set optimal route.

The transmission delay between the two routes can be found through a round trip time (RTT) of each route, and the sink node 100 can measure the RTTs of the two routes using a separate control packet.

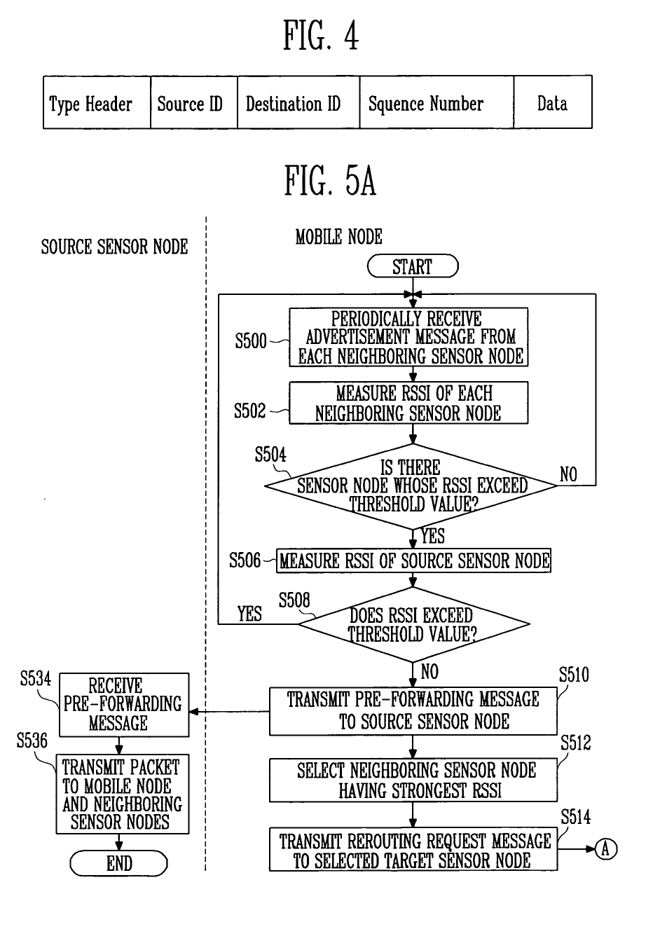

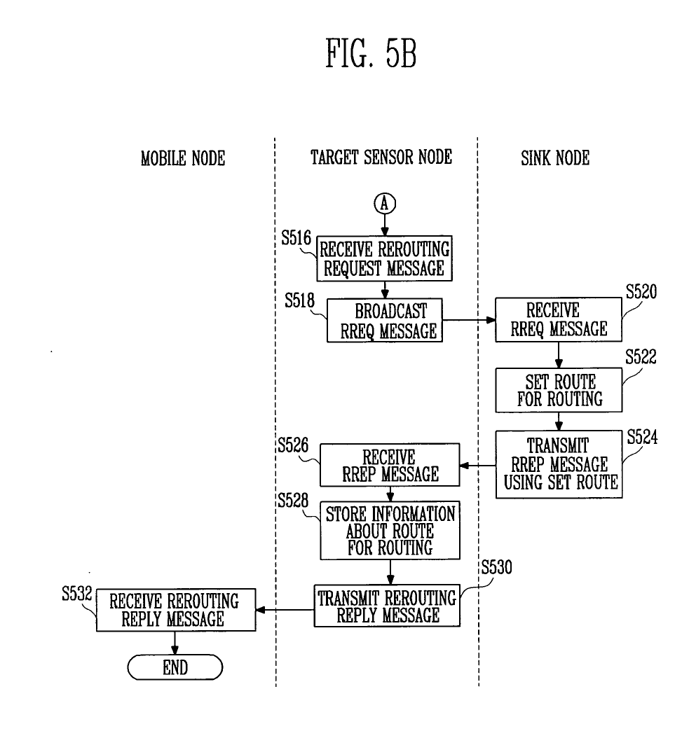

FIG. 2 is a schematic block diagram illustrating the configuration of a sensor node device for supporting seamless mobility of a mobile node in a sensor network according to the present invention, FIG. 3 illustrates the configuration of a routing table according to the present invention, and FIG. 4 illustrates a format of a data packet according to the present invention.

Referring to FIG. 2, the sensor node device for supporting mobility of a mobile node is comprised of a network interface 200, a buffer 210, an event handler 220 allocating an event to a module capable of processing the event when the event takes place, a transmission decision maker 230 deciding a transmission mode of a message, a mobility supervisor 240 controlling and managing functions based on whether or not the mobile node located within a service range of a sensor node moves, a location detector 250 allowing a current location of the mobile node to be accurately detected, a state reporter 260 reporting a current packet transmission state, and a routing table 248 having entire routes for packet transmission to the mobile node stored therein.

The network interface 200 is a module for communication, and manages communication with another sensor node, a mobile node, and a sink node.

When data received through the network interface 200 includes a message requesting various events, the data is stored in the buffer 210, and then processed by the event handler 220.

The event handler 220 allocates the data stored in the buffer 210 to a module capable of processing the event according to the type of the message.

To be specific, the event handler 220 transmits the event of interest to the location detector 250 when the event requires location information of each node, and to the transmission decision maker 230 when the event does not require location information of each node.

The transmission decision maker 230 decides a transmission mode according to circumstances when a message is received from the event handler 220.

Specifically, the transmission decision maker 230 decides the transmission mode according to location of the mobile node, and includes a forwarding handler 232 and a broadcasting handler 234.

The transmission mode according to the location of the mobile node is decided on the basis of a service range and a threshold distance of the sensor node. The forwarding handler 232 functions to hand over data to any neighboring sensor node, and the broadcasting handler 234 functions to transmit the data to all peripheral neighboring sensor nodes.

In other words, the forwarding handler 232 functions to simply forward data to another sensor node when the mobile node is outside of the service range, and forward a message to the mobile node when the mobile node is inside of the threshold distance.

The broadcasting handler 234 broadcasts the message to the peripheral neighboring sensor nodes when the mobile node passing the service range moves beyond the threshold distance. In this manner, the broadcasting handler 234 is a module for preventing packet loss while detecting the neighboring sensor nodes to prepare for switching.

Accordingly, the mobile node is provided with seamless service by means of the broadcast message even when entering into the range of another sensor node.

The mobility supervisor 240 functions to control and process functions depending on mobility of the mobile node located within the service range of the sensor node, and includes a sensor switching manager 242 deciding a sensor node to service the mobile node, a range estimator 244 detecting a current location of the mobile node to determine whether or not the mobile node is within the threshold distance of the sensor node, and a node information handler 246 managing the routing table 248 in order to provide the mobile node with service.

The sensor switching manager 242 functions to decide the sensor node providing service as the mobile node moves. To be specific, when the mobile node moves beyond the threshold distance, the sensor switching manager 242 predicts that the mobile node is likely to receive service from another sensor node in the future, and thus broadcasts a data packet to all peripheral neighboring sensor nodes through the broadcasting handler 234. When the mobile node does not completely move to another sensor node, the previous sensor node manages service for the mobile node.

The range estimator 244 determines whether or not the mobile node exceeds a threshold range of the sensor node on the basis of the location of the mobile node, and performs a necessary command. The threshold range refers to the threshold value of the distance between the mobile node and the sensor node currently transmitting data, and is expressed as an RSSI.

In other words, because the range estimator 244 stores the threshold value of the sensor node at present, the range estimator 244 determines whether or not the RSSI of the sensor node exceeds the stored threshold value. As a result of the determination, when the RSSI of the sensor node exceeds the stored threshold, the range estimator 244 determines that the mobile node is inside of the threshold range. In contrast, when the RSSI of the sensor node does not exceed the stored threshold, the range estimator 244 determines that the mobile node is outside of the threshold range.

Meanwhile, when it is determined that the mobile node is inside of the threshold range, the range estimator 244 causes the data to be transmitted to the mobile node through the forwarding handler 232 and the network interface 200.

However, when it is determined that the mobile node is outside of the threshold range, the range estimator 244 causes the data to be broadcast to the neighboring sensor nodes through the forwarding handler 232, and causes the neighboring sensor nodes to transmit the data within a service range.

The node information handler 246 functions to process information of the routing table managing the route of the mobile node. The routing table 248 is configured as in FIG. 3.

Referring to FIG. 3, the routing table 248 includes a Sink ID, a Moving Object ID, a Preceding Sensor ID, a Next Sensor ID, and a Time to Live.

When there is no packet transmission along a route for the duration of the Time to Live, the route is deleted.

The Sink ID refers to the ID of a sink node that broadcasts data, and the Moving Object ID refers to the ID of a mobile node that receives data. The Preceding Sensor ID refers to the ID of the sensor node that has handed over the data, and the Next Sensor ID refers to the ID of the sensor node to which the data will be handed over in the future.

When a data packet is received from the sink node or neighboring sensor node, the node information handler 246 checks whether or not a mobile node ID identical to the ID of a destination is listed in the routing table 248.

Here, the data packet is configured as in FIG. 4.

Referring to FIG. 4, the data packet includes Type Header, Source ID, Destination ID, Sequence Number, and Data fields. The Type Header field is information on whether a current packet is control information of a network or a service to be provided to the mobile node.

The Source ID field is information on from which sensor node the data packet comes, and the Destination ID field is information about to which mobile node the packet is transmitted. The Sequence Number field is information about the sequence of data in a service and is used as an ID number of the data packet.

As a result of checking, when the destination ID is not listed in the routing table 248 (i.e., when the mobile node first enters the transmission radius of the sensor node), the node information handler 246 registers the information of the mobile node in the routing table 248.

However, when the destination ID is listed in the routing table 248, the node information handler 246 determines through the range estimator 244 whether or not the mobile node is within the transmission radius of the sensor node.

The state reporter 260 functions to transmit the information about the data packet transmitted from the sensor node to a connected computer. The state reporter 260 includes a packet delay reporter 262 reporting packet delay.

The packet delay reporter 262 transmits a sequence number of the currently transmitted data packet and a temporal difference between the currently transmitted data packet and its previous data packet to the connected computer. The computer receiving a value of the temporal difference from the packet delay reporter 262 can plot a delay of each packet on a graph, and determine that a lost packet has no delay value.

When there are a plurality of mobile nodes, the buffer 210 functions to cause information about each mobile node to be on standby in the case where the information about each mobile node is processed by the event handler 220. In other words, the buffer 210 functions to temporarily store the data received through the network interface 200.

When the mobile node moves to a place where areas of radio wave propagation between the sensor nodes overlap each other, the sensor node device configured as described above allows sensor switching to be carried out by determining the threshold value and radio wave intensity of each sensor node.

Further, it is possible to reduce delay and packet loss when sensor switching is carried out using packet pre-forwarding according to the threshold value.

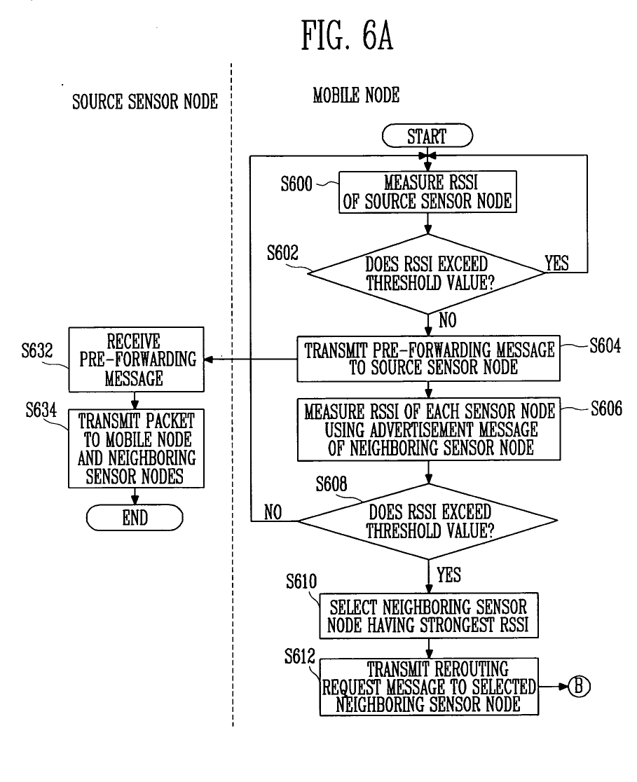

FIGS. 5A and 5B are flowcharts illustrating a method of processing handoff of a mobile node when a sensor node is mobile according to an exemplary embodiment of the present invention.

Referring to FIGS. 5A and 5B, the mobile node continuously receives Advertisement messages from neighboring sensor nodes (S500), and measures the RSSI of each of the neighboring sensor nodes using the received Advertisement messages (S502). Namely, when the mobile node begins to move, it can continuously receive the Advertisement messages from the peripheral neighboring sensor nodes and thereby detect the neighboring sensor nodes.

Thus, the mobile node measures the RSSI of each of the neighboring sensor nodes using the Advertisement message received from each of the neighboring sensor nodes. Each Advertisement message includes an ID and an RSSI threshold value of each sensor node.

After step S502, the mobile node determines whether or not there is any sensor node whose measured RSSI exceeds a preset threshold value (S504). The threshold value relates to a distance between the mobile node and a source sensor node currently transmitting data, and thus is expressed as an RSSI.

Therefore, because the mobile node stores a threshold value of the source sensor node, the mobile node determines whether or not there is a sensor node whose measured RSSI exceeds the stored threshold value.

When it is determined in step S504 that there is a sensor node exceeding the preset threshold value, the mobile node measures the RSSI of a packet transmitted from the source sensor node (S506). The mobile node measures the RSSI of a current sensor node using a data packet transmitted by the source sensor node or the Advertisement message periodically broadcast by the source sensor node.

After step S506, the mobile node determines whether or not the measured RSSI of the source sensor node exceeds the preset threshold value (S508).

When it is determined in step S508 that the measured RSSI of the source sensor node exceeds the preset threshold value, the mobile node is not handed off. This prevents handoff from occurring too frequently because a neighboring sensor node is excessively close to the mobile node.

However, when the measured RSSI of the source sensor node does not exceed the preset threshold value, the mobile node transmits a Pre-forwarding message to the source sensor node (S510).

The Pre-forwarding message indicates that the mobile node deviates from a transmission radius of the source sensor node and enters a transmission radius of another sensor node, and notifies the source sensor node that sensor switching will soon be performed.

When the Pre-forwarding message is received from the mobile node (S534), the source sensor node transmits a packet to be transmitted to the mobile node to the mobile node and the neighboring sensor nodes (S536).

In other words, the source sensor node transmits the packet arriving after the Pre-forwarding message is received to the mobile node as well as the neighboring sensor nodes.

The source sensor node receiving the Pre-forwarding message transmits the packet to the mobile node and simultaneously to the neighboring sensor nodes also, so that even when the mobile node deviates from a transmission range of the source sensor node, it can continue to receive packets without interruption.

Because the source sensor node does not know to which sensor node the mobile node performs sensor switching, the source sensor node simply transmits the packet to all neighboring sensor nodes managing areas adjacent to its transmission area.

Each neighboring sensor node receiving the packet from the source sensor node broadcasts the packet within its transmission radius. However, each neighboring sensor node does not know when the mobile node enters into its transmission range to prompt sensor switching.

Hence, each neighboring sensor node simply broadcasts the packet received from the source sensor node within its transmission radius, thereby minimizing delay and packet loss when sensor switching is performed.

After step S510, the mobile node selects the sensor node having the largest RSSI measured in step S502 (S512).

After step S512, the mobile node transmits a Rerouting Request message to the selected target sensor node (S514).

When the Rerouting Request message is received from the mobile node (S516), the target sensor node broadcasts a Routing Request (RREQ) message (S518).

Here, when the Rerouting Request message is received from the mobile node, the target sensor node creates the RREQ message including its address information and address information of a sink node.

Then, the target sensor node broadcasts the created RREQ message to neighboring sensor nodes. Each of the neighboring sensor nodes receiving the RREQ message compares its address with a destination address.

When its address is not identical to the destination address, each neighboring sensor node updates the received RREQ message, broadcasts the updated RREQ message to the neighboring sensor nodes, and causes the broadcast RREQ message to be transmitted to the sink node. The updated information includes a hop count.

Therefore, the RREQ message includes a mobile node ID, destination node address (sink node ID), hop count, and address of the sensor node broadcasting the RREQ message.

When the broadcast RREQ message is received in step S518, the sink node sets a route for routing (S522). Specifically, the sink node sets a route for routing using the hop count included in the transmitted RREQ message. For example, the sink node may set a route having the smallest hop count as a route for routing.

After step S522, the sink node transmits a Routing Reply (RREP) message to the target sensor node using the set route (S524). That is, the sink node transmits the RREP message to a first sensor node. Then, the first sensor node transmits the RREP message to the target sensor node using the stored routing table.

When the RREP message is received in step S524 (S526), the target sensor node stores routing information included in the RREP message (S528), and transmits a Rerouting Replay message to the mobile node (S530).

When the RREP message is received from the sink node, the target sensor node stores the routing information included in the RREP message in the routing table, and transmits the Rerouting Replay message to the mobile node.

When the mobile node receives the Rerouting Replay message from the target sensor node, handoff of the mobile node is completed (S532).

Then, the mobile node exchanges packets with the sink node using the set route.

As described above, after sensor switching is performed, the sink node sets the shortest route for exchanging data packets with the mobile node.

Then, the sink node measures an RTT of the current packet transmission route and an RTT of the set shortest route, and finds a transmission delay time between the two routes from the measured RTTs. Then, the sink node causes a sequence of data packets transmitted through the set shortest route after the transmission delay time to remain unchanged. Thereafter, the mobile node communicates with the sink node through the shortest route using the target sensor node.

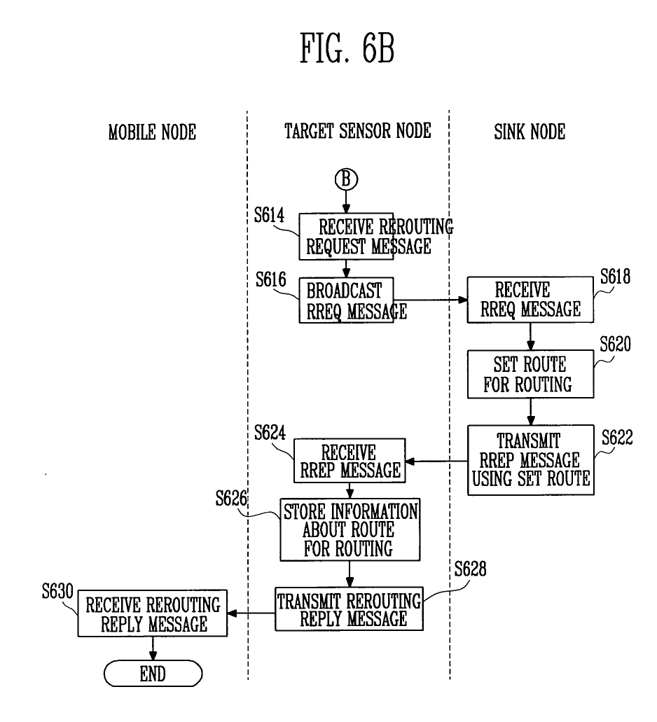

FIGS. 6A and 6B are flowcharts illustrating a method of processing handoff of a mobile node when a sensor node is stationary according to another exemplary embodiment of the present invention.

Referring to FIGS. 6A and 6B, the mobile node measures the RSSI of the source sensor node transmitting a current packet (S600), and determines whether or not the measured RSSI exceeds a preset threshold value (S602).

When it is determined in step S602 that the measured RSSI does not exceed the preset threshold value, the mobile node transmits a Pre-forwarding message to the source sensor node (S604).

When the Pre-forwarding message is received from the mobile node, the source sensor node transmits a packet to be transmitted to the mobile node to the mobile node and neighboring sensor nodes (S636).

After step S604, the mobile node measures the RSSI of each of the neighboring sensor nodes using Advertisement messages continuously received from the neighboring sensor nodes (S606). In other words, when the mobile node begins to move, it can continuously receive the Advertisement messages from peripheral neighboring sensor nodes and thereby detect the neighboring sensor nodes.

Thus, the mobile node measures the RSSI of each of the neighboring sensor nodes using the Advertisement message received from each of the neighboring sensor nodes.

After step S606, the mobile node determines whether or not there is a sensor node whose measured RSSI exceeds the preset threshold value (S608).

When it is determined in step S608 that there is a sensor node whose measured RSSI exceeds the preset threshold value, the mobile node selects the sensor node having the largest RSSI measured in step S606 (S610).

After step S610, the mobile node transmits a Rerouting Request message to the selected target sensor node (S612).

The processes following step S612 are the same as illustrated in FIG. 5 and so their description will be omitted.

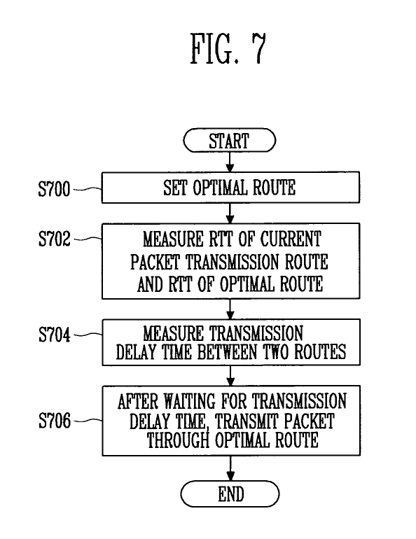

FIG. 7 is a flowchart illustrating a method of transmitting a data packet when a mobile node is handed off according to the present invention.

Referring to FIG. 7, when the mobile node is handed off and then a route is set, the sink node sets an optimal route for communicating with the mobile node (S700). Here, optimal route means the shortest route. A method of setting the optimal route may use, for instance, a hop count.

When the optimal route is set in step S700, the sink node measures an RTT of the current packet transmission route and an RTT of the set shortest route (S702).

In other words, the mobile node transmits a packet to the sink node using the route set by the handoff. Then, the sink node determines that the mobile node will stay in the radio wave propagation area of a current sensor node for a predetermined time without moving to another area, thereby measuring the RTTs of the current packet transmission route and the set shortest route.

After step S702, the sink node finds a transmission delay time between the two routes from the measured RTTs (S704).

After step S704, the sink node waits for the transmission delay time and then transmits packets using the set optimal route (S706).

In other words, the sink node finds the transmission delay time between two routes from the measured RTTs, and then causes a sequence of the data packets transmitted through the set shortest route after the transmission delay time to remain unchanged. This is because when the sink node sets the optimal route and then transmits the packet through the set optimal route, the packets may be transmitted to the mobile node out of sequence.

For example, when the sink node transmits a seventh packet through the existing route and then an eighth packet through the optimal route, the transmission delay of the optimal route is shorter. Hence, the mobile node can receive the eighth packet faster than the seventh packet. This causes a serious problem when the packets transmitted to the mobile node contain multimedia data.

For this reason, the change of the existing transmission route into the optimal route should take into consideration the sequence of the packets. In order to maintain the sequence of the transmitted packets, the sink node should wait for the duration of the transmission delay between the two routes before changing the existing route into the optimal route.

After the mobile node waits for the transmission delay time found as described above, the mobile node communicates with the sink node through the optimal route using the target sensor node. Then, the optimization of the route solves the problem that as movement of the node gradually increases, the packet transmission route increases in the sensor network, thus causing unnecessary waste of bandwidth and long transmission delay.

The inventive method as described above can be implemented by a program and stored in a recording medium in a computer-readable form. This process can be easily put into practice by a person having ordinary skill in the art to which the present invention pertains, and thus will not be described herein.

As can be seen from the foregoing, the present invention provides a sensor node device and method for supporting mobility of a mobile node in a sensor network, in which location information of the mobile node is detected by sensor nodes, so that the sensor node can receive seamless data from the nearest sensor node as the mobile node moves.

Further, the present invention provides a sensor node device and method for supporting mobility of a mobile node in a sensor network, in which when the mobile node moves to a place where radio wave propagation areas of sensor nodes overlap each other, the radio wave intensity of each sensor node is detected to perform a handoff to the sensor node of the area having the strongest radio wave intensity. Accordingly, the ping-pong problem of unnecessary repeated handoff, and the delay problem of too slow handoff, can be prevented.

Also, the present invention provides a sensor node device and method for supporting mobility of a mobile node in a sensor network, in which when the packet transmission radius of the sensor node is limited to a predetermined distance, a threshold value of the distance is preset to prevent packet loss.

Further, the present invention provides a sensor node device and method for supporting mobility of a mobile node in a sensor network, in which the route is optimized to cope with unnecessary waste of bandwidth and long transmission delay caused by continuous increase in movement of the node and complexity of the packet transmission route in the sensor network.

Further, the present invention provides a sensor node device and method for supporting mobility of a mobile node in a sensor network, capable of supporting continuous mobility which is suitable for a wireless sensor network environment and minimizes packet loss.

Further, the present invention provides a sensor node device and method for supporting mobility of a mobile node in a sensor network, capable of providing the mobile node with seamless service even when the mobile node enters the transmission range of another sensor node, due to use of a broadcast message.

Further, the present invention provides a sensor node device and method for supporting mobility of a mobile node in a sensor network, in which a sensor node receiving a Pre-forwarding message transmits a packet to the mobile node and simultaneously to neighboring sensor nodes, so that the mobile node can seamlessly receive packets even when it is outside of the transmission radius of the sensor node.

In addition, the present invention provides a sensor node device and method for supporting mobility of a mobile node in a sensor network, capable of improving the efficiency of data transmission through optimization of the packet transmission route.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A sensor node device for supporting mobility of a mobile node in a sensor network, the sensor node device comprising:
a network interface for communicating with a sink node, at least one neighboring sensor node, and the mobile node;
a mobility supervisor for detecting a location of the mobile node, and deciding a sensor node for a service of a data packet received through the network interface on the basis of the detected location;
a transmission decision maker for deciding a transmission mode for the data packet received through the network interface according to the location of the mobile node; and
a state reporter for reporting a transmission state of the data packet through the sensor node device.

2. The sensor node device according to claim 1, further comprising a buffer for temporarily storing the data packet received through the network interface.

3. The sensor node device according to claim 1, further comprising an event handler for, in processing the data packet received through the network interface, transmitting the data packet to the mobility supervisor when the location of the mobile node is required, and transmitting the data packet to the transmission decision maker when the location of the mobile node is not required.

4. The sensor node device according to claim 1, wherein the transmission decision maker comprises a forwarding handler for transmitting the data packet to a specific one of the neighboring sensor nodes, and a broadcasting handler for broadcasting the data packet to the peripheral neighboring sensor nodes.

5. The sensor node device according to claim 1, wherein the mobility supervisor comprises:
a range estimator detecting the location of the mobile node and determining whether or not the mobile node is located within a threshold range of the current sensor node;
a sensor switching manager deciding the sensor node for the service according to the determination of the range estimator; and
a node information handler storing a routing table which is used to manage a route of the mobile node.

6. The sensor node device according to claim 5, wherein the threshold range is a threshold value of a distance between the mobile node and the sensor node, and is expressed as a Received Signal Strength Indication (RSSI).

7. The sensor node device according to claim 4, wherein the sensor switching manager transmits a data packet transmission message to the forwarding handler so as to allow the data packet to be transmitted to the mobile node when the mobile node is determined by the range estimator to be within a threshold range, and transmits the data packet transmission message to the broadcasting handler so as to allow the data packet to be transmitted to the peripheral sensor nodes when the mobile node is determined by the range estimator not to be within the threshold range.

8. The sensor node device according to claim 5, wherein the routing table comprises an identification (ID) of the sink node, an ID of the mobile node, an ID of the preceding sensor node, an ID of the next sensor node, and information on a time for which a rout lasts.

9. A method for supporting mobility of a mobile node in a sensor network, the method comprising the steps of:
determining, by the mobile node, whether or not sensor switching is required using a Received Signal Strength Indication (RSSI) of each sensor node and a threshold value;
when it is determined that sensor switching is required, deciding a target sensor node using the RSSI of each sensor node and the threshold value;
performing a handoff to the decided target sensor node;
setting an optimal route through the decided target sensor node; and
transmitting/receiving a data packet using the set optimal route.

10. The method according to claim 9, wherein the step of determining, by the mobile node, whether or not sensor switching is required using a Received Signal Strength Indication (RSSI) of each sensor node and a threshold value comprises the steps of:
measuring the RSSI of each neighboring sensor node using an Advertisement message periodically transmitted from each neighboring sensor node;
determining whether or not there is a neighboring sensor node whose measured RSSI exceeds the threshold value preset;
when it is determined that there is a neighboring sensor node whose measured RSSI exceeds the preset threshold value, measuring the RSSI of a source sensor node performing a current data packet service; and
when the measured RSSI of the source sensor node does not exceed the threshold value, determining that sensor switching is required.

11. The method according to claim 10, further comprising the step of: when the measured RSSI of the source sensor node does not exceed the threshold value, transmitting a Pre-forwarding message to the source sensor node.

12. The method according to claim 11, wherein the Pre-forwarding message is a message notifying the source sensor node that sensor switching is performed.

13. The method according to claim 10, wherein the Advertisement message comprises an identification (ID) of the sensor node and a threshold value of the RSSI.

14. The method according to claim 9, wherein the step of determining, by the mobile node, whether or not sensor switching is required using a Received Signal Strength Indication (RSSI) of each sensor node and a threshold value comprises the steps of:
measuring the RSSI of a source sensor node performing a current data packet service;
when the measured RSSI of the source sensor node does not exceed the threshold value, measuring the RSSI of each neighboring sensor node using an Advertisement message periodically transmitted from each neighboring sensor node; and
when there is a neighboring sensor node whose measured RSSI exceeds the threshold value preset, determining that sensor switching is required.

15. The method according to claim 9, wherein the step of, when it is determined that sensor switching is required, deciding a target sensor node using the RSSI of each sensor node and the threshold value comprises the step of deciding as the target sensor node the sensor node having the strongest RSSI among the neighboring sensor nodes.

16. The method according to claim 9, wherein the step of performing a handoff to the decided target sensor node comprises the steps of:
transmitting a Rerouting Request message to the target sensor node;
when the Rerouting Request message is received from the target sensor node, creating a Routing Request message and transmitting the created Routing Request message to a sink node;
when the Routing Request message is received, setting, by the sink node, a route for routing and transmitting a Routing Reply message based on the set route; and
when the Routing Reply message is received from the sink node, storing, by the target sensor node, information about the route for routing and transmitting a Rerouting Reply message to the mobile node.

17. The method according to claim 9, wherein the step of transmitting/receiving a data packet using the set optimal route comprises the steps of:
measuring a first round trip time of a current data packet transmission route and a second round trip time of the set optimal route;
finding a transmission delay time using the measured first and second round trip times; and
after waiting for the found transmission delay time, transmitting/receiving the data packet using the set optimal route.

18. A method for processing handoff of a mobile node in a sensor network, the method comprising the steps of:
measuring a Received Signal Strength Indication (RSSI) of each neighboring sensor node using an Advertisement message periodically transmitted from each neighboring sensor node;
determining whether or not there is a neighboring sensor node whose measured RSSI exceeds a preset threshold value;
when it is determined that there is a neighboring sensor node whose measured RSSI exceeds the preset threshold value, measuring the RSSI of a source sensor node performing a current data packet service;
when the measured RSSI of the source sensor node does not exceed the threshold value, transmitting a Pre-forwarding message to the source sensor node and deciding as a target sensor node the sensor node having the strongest RSSI among the neighboring sensor nodes;
transmitting a Rerouting Request message to the target sensor node; and
when the Rerouting Request message is received from the target sensor node, transmitting/receiving a data packet through the target sensor node.

19. The method according to claim 18, wherein the source sensor node receiving the Pre-forwarding message transmits the data packet to be transmitted to the mobile node to the mode node and the neighboring sensor nodes.

20. The method according to claim 18, wherein the step of transmitting the Rerouting Request message to the target sensor node comprises the steps of:
when the Rerouting Request message is received from the mobile node, creating, by the target sensor node, a Routing Request message and transmitting the created Routing Request message to a sink node;
when the Routing Request message is received, setting, by the sink node, a route for routing and transmitting a Routing Reply message based on the set route; and
when the Routing Reply message is received from the sink node, storing, by the target sensor node, information about the route for routing and transmitting a Rerouting Reply message to the mobile node.
